(19) United States
(12) Patent Application Publication
(10) Pub. No.: US 2019/0359380 A1
(43) Pub. Date: Nov. 28, 2019

(54) NESTABLE ONE QUART HALF GALLON AND ONE GALLON SIZE PAINT CANS FOR OPENING AND CLOSING THEM WITHOUT THE NEED OF ANY TOOLS

(71) Applicant: Heinz Welschoff, Pompano Beach, FL (US)

(72) Inventor: Heinz Welschoff, Pompano Beach, FL (US)

(21) Appl. No.: 16/417,975

(22) Filed: May 21, 2019

Related U.S. Application Data
(60) Provisional application No. 62/675,316, filed on May 23, 2018.

(51) Int. Cl. B65D 21/04; B65D 21/02; B44D 3/12; B65D 41/04

(52) U.S. Cl. CPC B65D 21/048; B65D 21/0233; B65D 2251/023; B65D 41/0485; B44D 3/128; B44D 3/127

(57) ABSTRACT

A nestable paint container having a main body can having a used true can bottom, the can for receiving paint, the paint body having tapering sidewalls having an outwardly tapering can about the top to bottom of the main body can; a circumferential paint high can cover and grooved against an uppermost region beneath a rim of an upper side of the main body can; a small central can cover cap about an open small circular center over the top of the small central can cap; a spline gripping element substantially circular the cover but outwardly of the can cover and inwardly of the can of the rim; and a drip spout of the inside of the lower of the small central open cap and with a spline gripping element.

### REFERENCE TO RELATED APPLICATION

This application claims the benefit under 35 USC 119(e) of provisional patent application Ser. No. 62/675,316, filed May 23, 2018, which is incorporated by reference in its entirety.

### FIELD OF THE INVENTION

The invention relates to paint cans and more particularly, using a multiplicity of nestible can systems.

### BACKGROUND OF THE INVENTION

Paint cans are made out of metal or plastic and are commonly used to fill with paint products and to be protected from any damage. The existing types of one quart and one-gallon paint cans are made out of plastic or metal, and contain more than three parts, as various machine and hand labor operations. Some existing types of plastic or steel paint cans also use more than three parts, machine operations and personal hand labor. The existing metal or plastic cans covers are in need of opening tools, to close the cover with a press, commonly with the use of a hammer. There is also the noise factor when closing the cover with the hammer. Both operations are time consuming, therewith with a hand/wrist liability. When closing the cover with a hammer, any paint left-over inside the groove of the can will splash all over. Also, paint most of the time rundown at the outside of the can and thus this would rarely be cleaned.

One approach to eliminating this problem has been to provide an inner lip on the bucket, so that excess paint wiped against the tip drips back into the bucket and not on the floor. Examples of such buckets include: As well, U.S. Pat. No. 6,609,629 to Lucey, which has a lip extending outboard and sitting proud on its rim, with a configuration said to allow multiple bucket to be stacked. U.S. Pat. No. 4,615456 to Cousar shows a modular bucket with space for a brush to rest. U.S. Pat. No. 1,696,240 to Kircher, Jr. shows a metal bucket having a lip brace extending radially between its rim and lip; the brace is generally coplanar to the rim. Neither of the above patents describes a loop brace attached below to the rim to a sidewall of a paint bucket, with the brace forming a trough for stowage of applicator brush or rollers, nor is such a bucket described that is optionally stackable for retail display.

Other art of interest are U.S. Pat. No. 3,442,420 to Edwards, U.S. Pat. No. 4,181,226 to Weinert, and U.S. Pat. No. 7,428,977 to Fera with a Dripless Paint Bucket.

Other problems with metal can covers such as after a short time, the cans and their covers start to rust. Many times, the cover is not completely sealed, then the paint in a short time become dry, useless and wasteful. Also, it creates an environmental problem. The plastic paint cans basically have the same problems as the metal ones. Some plastic paint cans also have metal parts. This create a dual problem. Drying paint and the metal part also start to rust.

Both types of paint cans are very hard to be completely cleaned. Most painters do not take the time to clean inside and under the cover groove at the top.

As is known, manufacturer produces the one quart and one-gallon paint cans, metal or plastic and to store in boxes at the company. When shipping these cans and place in boxes, there is considerable wasted space and costs.

### SUMMARY OF THE INVENTION

A nestable one quart, half gallon and one-gallon paint can have a main angle body, bottom of the main body shown the round leg's, at the top end and the outside of the can is a ring with a hallow inside groove. The paint can body above the hallow grooved ring is a vertical straight threading. An internal threaded paint can cover that screws unto the external vertical straight treading of the paint can. The paint can cover contains an extended hallow neck and the extended neck contains an external thread. The can cover contains a round spline ring thus for the use of screwing and unscrewing to and from the threaded can body. The can cover with the extended external threaded neck is to receive the internal threaded cap.

It is an object of the present invention to provide an improved stacking device in the bottom wall of a thin wall thermoplastic or steel nestable container.

Another object is to provide a thin-wall plastic or steel container having a bottom stacking device which is not difficult to form, consistently functioning as a stacking device and yet does not interfere, to any great extent, with the volume or capacity of the container.

A further object of the present invention is to provide a bottom stacking system in a thin-walled seamless thermoplastic or steel container which, in other forms of the present invention, is easy to remove from molding machinery and yet provides a stacking function consistent with industry standards.

It is also known that complete manufacturing process is without the complicated and costly assembly lines, machinery, operating and maintenance cost, and is fast, simple, no manual labor, space savings, shipping savings and much cleaner.

As well, all paint cans, covers and caps can be molded in any color and sellers of the paint can and paint, are now have the color and logo designed per each company.

In a preferred embodiment, the rim, bottom and sidewall dimensions of the bucket are shaped and sized to allow stacking of multiple buckets for retail display. More preferably, the buckets are of a unitary molded plastic or steel construction.

Other objects and advantages will become apparent to a reader skilled in the art, with reference to the following Figures and accompanying Detailed Description wherein textual reference characters correspond to those denoted on the drawings.

### BRIEF DESCRIPTION OF THE DRAWINGS

FIG. 1 provides a complete vertical assembled rear view of my inventive paint can.

FIG. 2 is a vertical assembly opposite side view of that of FIG. 1.

FIG. 3 provides vertical assembly front view having arc-shaped body with a lowermost base front cut-out opening and false bottom.

FIG. 4 is an assembly top view and cover view of the cap.

FIG. 5 is a perspective assembly of the top and front view, said view of the base cut-out opening.

FIG. 6 is a front and top view of the can only.

FIG. 7 is a top and front view of the cover.

FIG. 7A is a top partial view of the top in combination with the beginning of the spout.

FIG. 8 is a top view of the high splined gripping cap.

FIG. 8A is a first ring for a cap of can.

FIG. 8B is a second ring of a cap that is particularly useful with the threading of the cover.

FIG. 9 is a side view of the can showing the front base cut out.

FIG. 10 is a front vertical view of the cans inserted into each other also showing the front base cut out.

FIG. 11 is a vertical cut away view whereas the cans are inserted into each other.

FIG. 12 is a front view of two cans covered with the cover stacked into each other also showing the front base cut-out opening and false bottom.

FIG. 12 and FIG. 14 are views of an inner spline of a special purpose wrench as used for the opening or closing of the cap of the threaded cover neck of FIGS. 7 and 7A.

FIG. 14A is a view of FIG. 4 outside of space cover 130 with cap removed showing the neck opening 136.

FIG. 15 and FIG. 16 are top and side views of the special wrench for opening and closing of said threaded cover neck of the inner spline walls.

FIG. 17 and FIG. 18 are open and closed threadings about the top and bottom aspects of the cap and the cover.

FIG. 19 is the outer spline of the wrench of FIG. 13, that can be seen about the can cover.

FIG. 20 and FIG. 21 are bottom and side views of said special wrench which closes or opens the outer wall and inner spline of the inner spline space of the wrench.

### DETAILED DESCRIPTION OF THE INVENTION

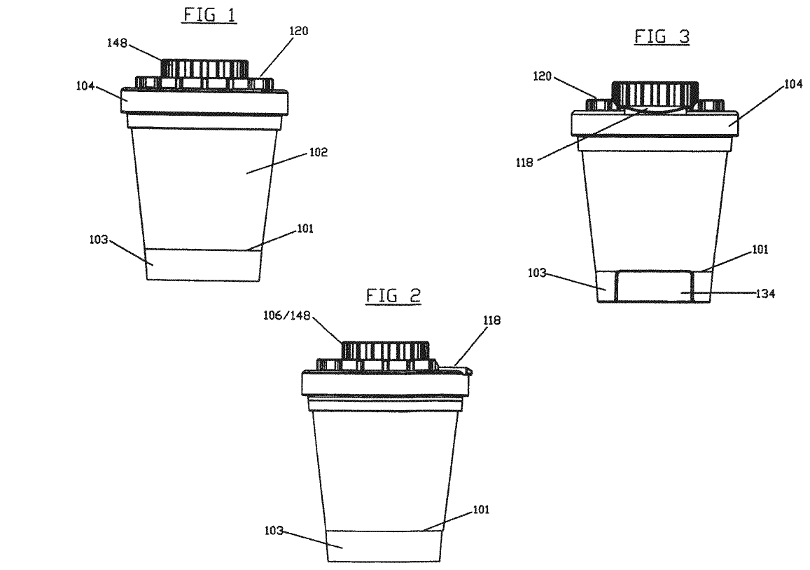

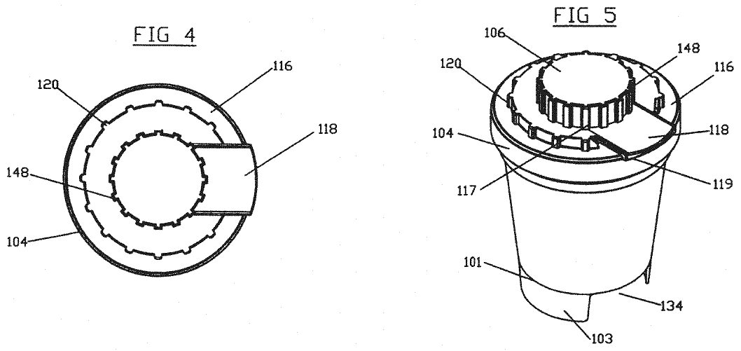

With regard to FIGS. 1-2 are shown a present inventive paint can, specifically shows a main can as said 102 in which provides a can cover 104 over which is gripping spline 120 (see also FIG. 4) which exists over said can cover 104. Also provided in FIGS. 2 and 5 is high can cover 106. As such, the vertical assembly is shown in the vertical rear view thereof.

As may be seen, main can body 102 exists along all sidewalls of the body.

Further, the structure provides for a bottom of the can 103 and a false bottom 101 (more fully described below).

In cover 104 is shown in FIGS. 1-5 and as the gripping spline of cover 120

In FIG. 2 is an opposite view of FIG. 1 where the view of FIG. 1 appears identical, this is a top view in FIG. 4.

In drop spout 118 (see also FIG. 4) exists the edge before the gripping spline of the cap 148. As such, the drip spout 118 is shown in FIGS. 3, 4, 7 and 7A, however in top plan view all of threaded cover neck 138 and 138A. There are no threads on one side of open end 136 of FIGS. 7 and 7A. Also shown is the false bottom 103 of the can body 102 and, therein, the true bottom 101 as is shown in FIGS. 3, 5 and 6. Further to FIG. 4 is shown gripping spline 120 for the essential aspect of the cap 106/148 and said spline 120. Relative to the can cover 104 and, between the can cover 104 is the gripping spline of the cap 120. Said can cover 104 and spline 120, and cap 148 provide both the cover and perspective views are shown in FIGS. 4 and 5.

In FIGS. 4, 5, 7 and 7A, the spout 118, 118A and 118B is shown in several particular aspects thereof. I.e., an innermost location 138A exists relative to the threaded cover 138 therewith, and the outermost spouts 118A and 118B exist at the upper edge of cover 104.

In FIG. 7, the threaded region 138 is circumferential about the top of 138. Also, in FIG. 7A only the area 119 initiates the drip spout 118 and before ends 118A and 118B.

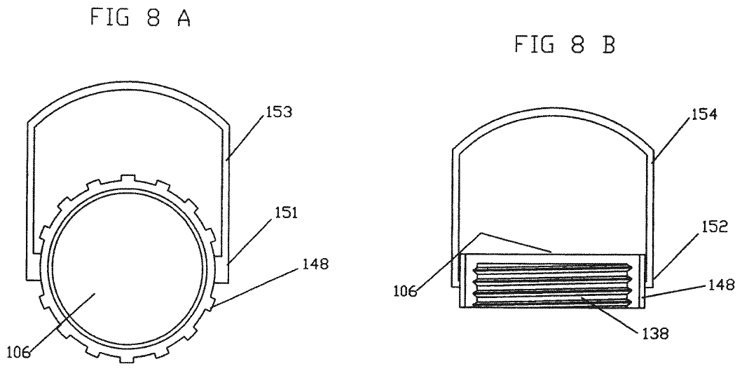

In FIG. 8A is a first ring 153 for a cap 106 of the can with element 151 at an interface between cap 148 and element 151.

In FIG. 8B is a second ring 154 for a cap 106 of the can with element 152 at an interface between cap 148 and element 152 that is particularly useful with the threadings 138 of the cover 148.

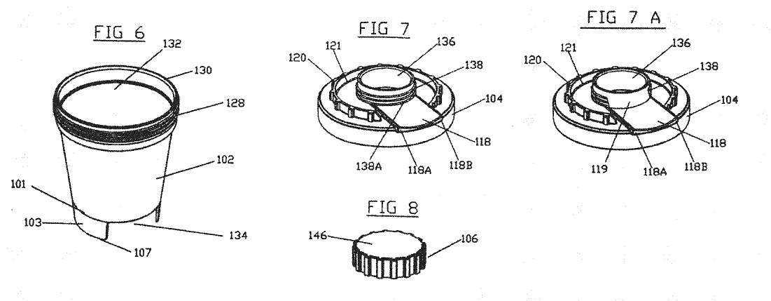

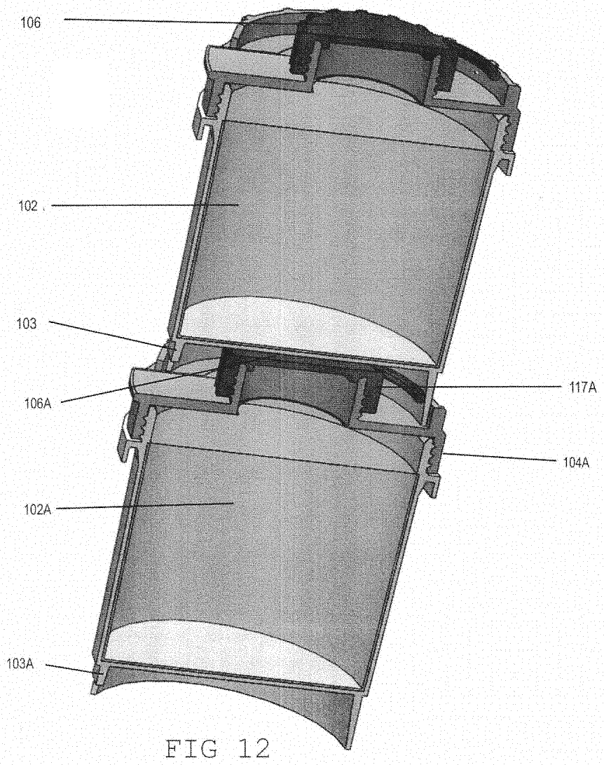

Therein, when paint is cut into can body 102, the lowermost part the true can bottom 101 (see FIGS. 1-3 and FIGS. 5, 6, 9, 10, 11) is the false bottom 103 includes a cut-out region 134 (see FIGS. 3, 5, 6, 9-10 and 12). That is, from a bottom view, FIGS. 5 and 6, the true can bottom opening 101 above the false bottom 103.

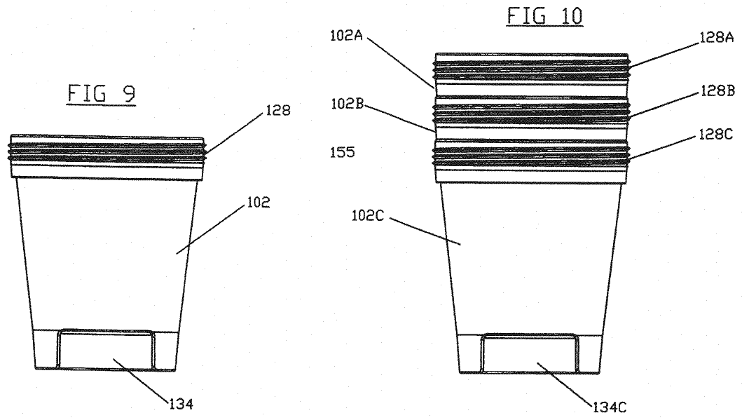

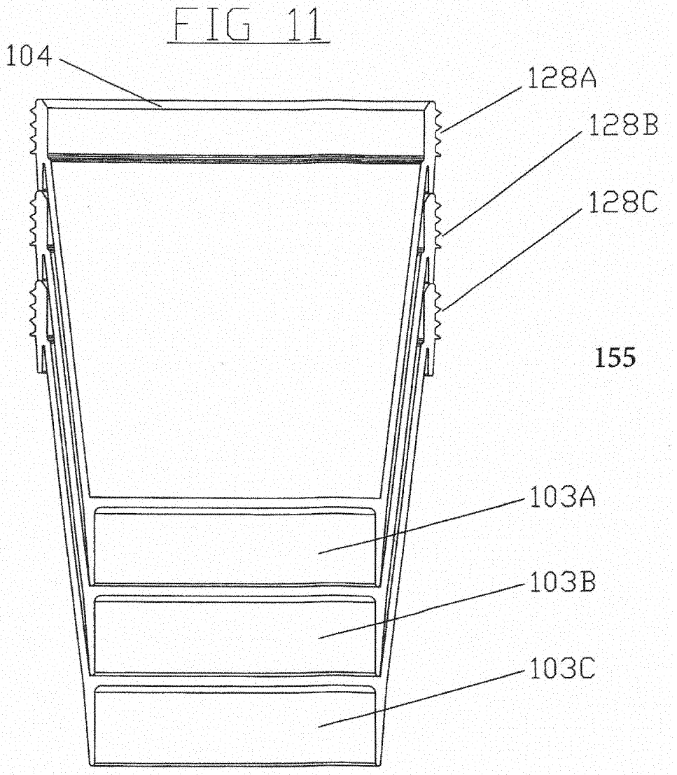

In FIG. 6 is also shown paint can body opening 132. Therein, a paint can body edge 130 can also be used as the paint can body 102. Further shown therein are the use of paint can body threads 128 (see FIGS. 9-10) wherein to enable angulations of can cover 102 whenever the closure of can body opening 132 is required by can cover 104. (See FIGS. 1 and 5).

See also the stackable items 155 as can be shown in FIGS. 10-12.

See covers 102A, 102B, 102C as well as 134C can body threads 128A, 128B, 128C (FIGS. 10-12). Also shown false bottoms 103A, 103B, 103C, as well as top edge 104.

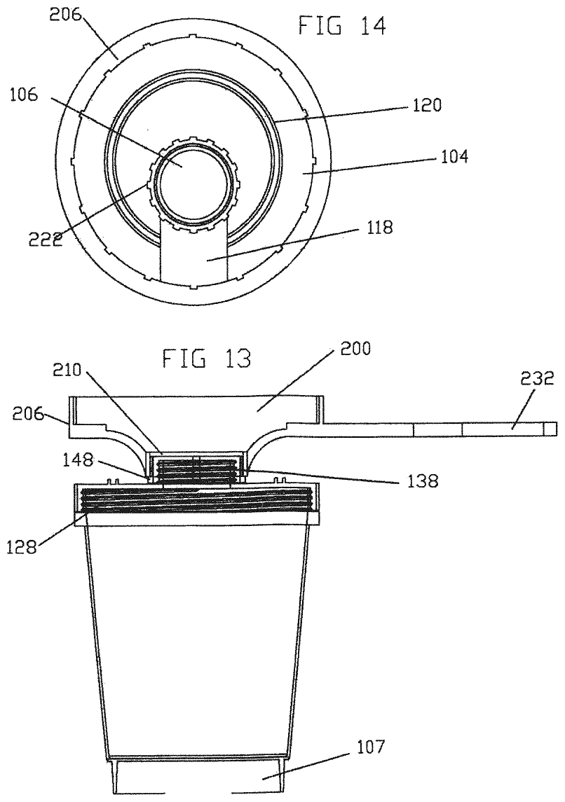

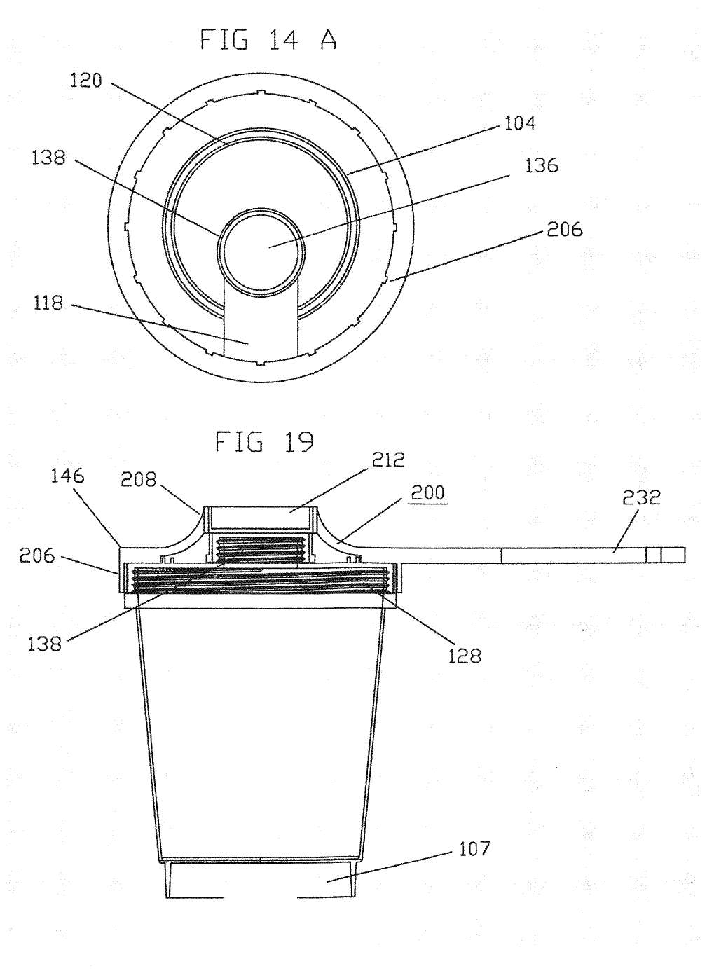

FIGS. 13 and 14 are views of an inner spline 222 of the special purpose wrench 200 as used for the opening or closing of the cap 148 of the threaded cover neck 138 of FIGS. 7 and 7A. As may be seen the particular wrench provides a given geometry to 210 which specifies operation with the inner spline 222 as to its outer spline 206 but out of its innermost cover neck 138 such use at cap 148. Said wrench 200 with its handle 232 provides a high degree of leverage against the spline 222 of the cap 106. Therein said outer spline 206 can urge against both sides of FIGS. 14 and 14A of the outer spline 206.

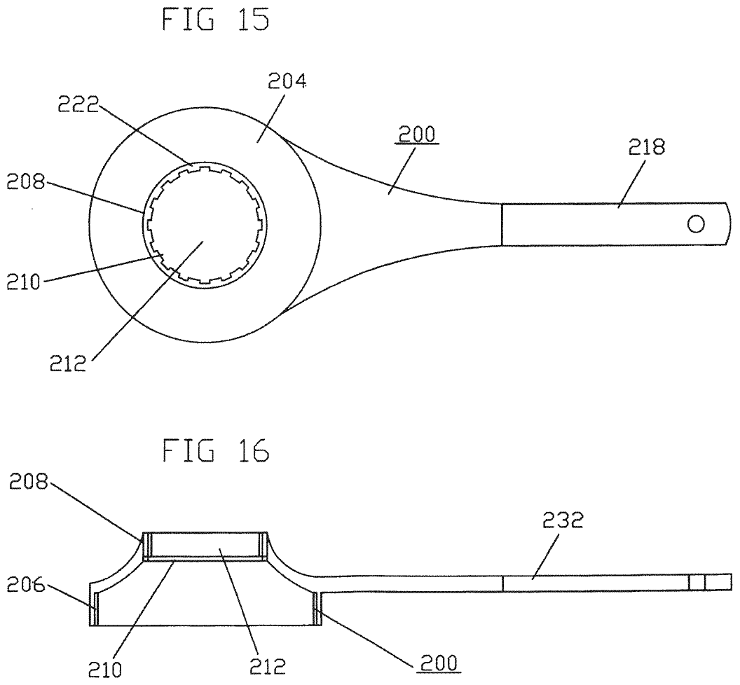

FIGS. 15 and 16 are top and side views of said special wrench 200 for opening and closing of said threaded cover neck 138 of the inner spline 222. Also, shown is outer wall height 208 of the inner spline. Also, shown is inner spline 222 of central empty space 212 of the wrench to be placed on top of the cap 106/148 connecting to the cap with inner walls 208 and bottom 210 of the central empty space 212.

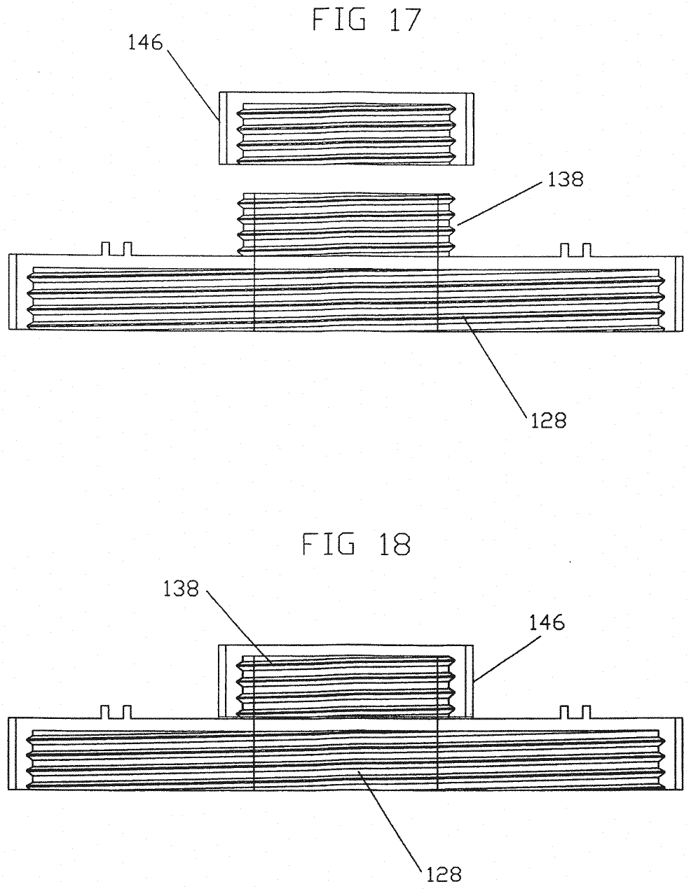

FIG. 17 is a side cut view of the cover 104 with the cap 148 being removed from the neck of the cover showing the threads on the outside surface of the can 138 and threads on the inside surface of the cover 128 in open position.

FIG. 18 is a side cut view of the cover 104 with the cap 148 closing the neck of the cover showing the threads 138 on the outside surface of the can and threads 128 on the inside surface of the cover in closed position.

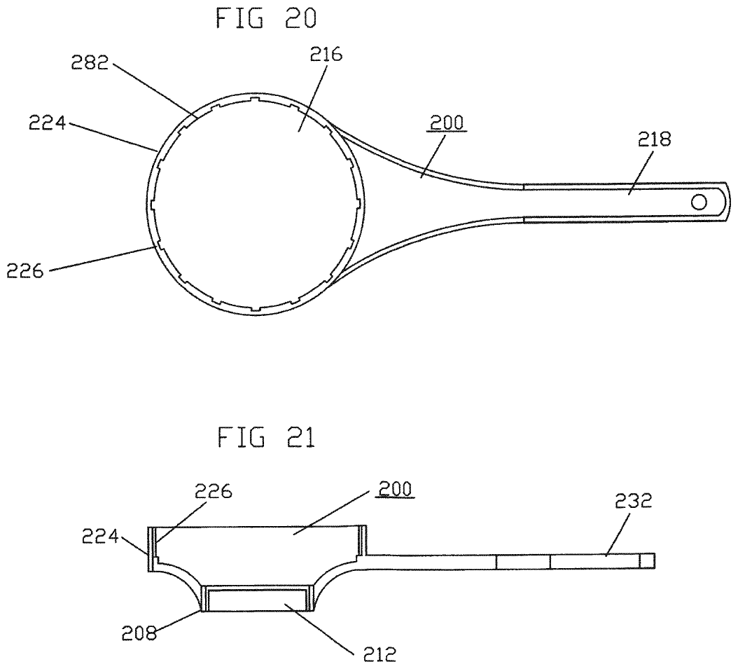

FIGS. 20 and 21 are top and side views of said special wrench 200 for opening and closing of said cover by gripping the cover 120 (see FIG. 4) with inner spline 226 of the height spline 282. Also, shown is outer wall 224 of the height spline 282, and a bottom 216 of the empty space for connection to the cover.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A nestable paint container, comprising:
(a) a main body can having an used true can bottom, the can for receiving paint, said paint body having tapering sidewalls having an outwardly tapering can about a top to bottom of the main body can;
(b) a circumferential paint substantial high can cover against an uppermost region of an upper side of the main body can;
(c) a small central can cover cap about an open small circular center over said top of said small central can cap; and
(d) a drip spout of the inside of the lower of said central open cap and with a spline gripping element.

2. The container as recited in claim 1, comprising:
(e) a spline gripping element substantially circular said cover but outwardly of said can cover and inwardly of said can of said rim.

3. The container as recited in claim 1, comprises:
(f) paint can body defining a false bottom defining an arc-like region, said false bottom within which a beneath stackable can beneath a second can cover and an associated cap can maintain can cover cap with said each false bottom above.

4. The container as recited in claim 2, comprising:
(g) having a lowermost surface about centermost gripping spline of the top; and
(h) a paint filling opening enable for tripping from within center of the cover spout and therein past said cover spout.

5. The container as recited in claim 2, comprising:
(i) cover spout can cover into the drip spout and across the vertical area of the can body in the direct of said arc-like beneath said each false bottom of the main body can.

6. The container as recited in claim 2, comprising:
(j) said false bottom generally circumferential with the amount tapering of each body can.

7. The container as recited in claim 3, comprising:
(k) a multiplicity of nestable can bodies stacked within each other thereof.

8. The container as recited in claim 2, comprising:
a tool to open and close of a gripping spline of can cover cap.

9. Paint cans for molded and reusable nestable containers, comprising:
(a) a plurality of main body cans;
(b) each having an internal threaded top cover with an external gripping spline for ease of removal, installation and cover to the can body cans;
(c) each can having an external hollow threaded neck;
(d) each having an external drip spout to protect the paint from flowing into the cover and down each body cans; and
(e) each having an internal threaded high splined cap for easy to install and to remove from said hollow external threaded cover neck;
(f) each can body molded in one part, after the molding completed within a few seconds, the can body placed unto the assembly line and a robot system picks up the can body and place in into a box in an external stackable fashion;
(g) each top cover and cap molded separately with each cap screwed unto the top threaded cover external threaded caps and internal threaded top covers placed into a box.

10. The paint cans as recited in claim 9, comprises:
(h) each can body molded in one part, after the molding completed within few seconds, the can body placed unto the assembly line and a robot system picks up the can body and place it into a box in an external stackable fashion;

11. The system as recited in claim 10, comprising:
(i) each top cover and cap molded separately with each cap screwed unto the top threaded cover external threaded caps and external threaded top covers placed into a box; and
(j) the internal threaded caps and internal to threaded top of covers placed into the box.
